(19) United States
(12) Patent Application Publication
(10) Pub. No.: US 2004/0263335 A1
(43) Pub. Date: Dec. 30, 2004

(54) Method for tracking and tracing marked packaged articles

(76) Inventor: Charles J. Molnar, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/837,065

(22) Filed: Apr. 30, 2004

Related U.S. Application Data
(60) Provisional application No. 60/466,649, filed on Apr. 30, 2003.

(51) Int. Cl. G08B 13/14; G08B 1/08

(52) U.S. Cl. 340/572.1; 340/539.13; 340/5.8

(57) ABSTRACT

The present invention relates to a method for detecting the occurrence of fraud in commercial transactions. The present invention is a method of tracking and tracing marked articles through the flow of commerce wherein information obtained from markers is stored in a covert memory and analyzed as to authenticity. The present invention is also a method for determining trends in fraudulent activity relating to that marked article.

This application claims the benefit of U.S. Provisional Application No. 60/466,649, filed Apr. 30, 2003.

### BACKGROUND OF THE INVENTION

1. Field of the Invention

The present invention relates to a method for detecting the occurrence of fraud in transactions involving marked articles. The present invention more particularly relates to a method of tracking and tracing marked articles through the flow of commerce.

2. Description of the Prior Art

In order to prevent fraud during the conduct of commerce, it has become conventional to mark articles of commerce in some manner, in order to identify the article and/or verify that the article is authentic and has been made and/or sold legally. Legitimate businesses such as manufacturers, suppliers, distributors, and/or vendors are concerned with the growth of various fraudulent practices in commercial transactions. Examples of fraudulent practices that are of concern to legitimate businesses include: diversion; dilution; and counterfeiting. Perpetrators of fraud (hereinafter, predators) use illicit tactics to divert profits from legitimate business concerns, and these tactics can also include theft of the authentic goods.

For example, diversion is a practice whereby authentic product is diverted from being sold in a market in which the product was intended to be sold at a low market value, but is rerouted by a predator to another market where the product can be sold at a higher market value. Often the market of lower value is a market that is one that is needy but unable to pay the higher market value. For example, pharmaceuticals intended for a poor country can be repackaged and sold in another market at a high profit margin to the predator. Diverted product thus can re-route profits from the legitimate business concern to the predator while at the same time depriving a poor population of needed goods. Dilution is a fraudulent practice whereby an authentic product is mixed with an inactive ingredient and the product is represented as being identical to an unmixed product. Counterfeiting is producing a copy of an original article and passing it off as an authentic original article, that is, the article that was copied.

Marking is one method that is used to prevent these fraudulent practices. Methods of marking include overt methods, whereby the marked item is identified in such a manner as to make it apparent to an observer (customer, merchant, predator, or the like) that the item is in fact marked. An overt mark can also be one that provides easily accessible or readily displayed information about the authenticity of the article to the principals in the transaction. The overt marking can be a visual design that is so unique that it will be apparent that the item is authentic, or a mark that will provide product information to a sensing or signal reading device. Overt markings can include, for example, bar codes on the external surface of the marked article, fluorescent ink or pigments easily visible to the naked eye; holograms; trademarks; logos; labels; and unique color schemes. Overt marking has the advantage of being readily apparent to a possible predator and/or merchant that the item is identifiable, and thus can discourage fraud. U.S. Pat. No. 6,351,537 B1 describes an article having an overt verifiable holographic image.

Covert marking is a marking practice wherein an article is marked using an identifier that is not easily seen by a consumer. For example, covert markings can be placed below the surface of an article such that it is hidden from sight, or positioned on the inside of a container, or provided in a form that is not readily distinguishable from other components or features of the article being marked, or the marker can be of a type that can only be identified with the aid of a “reading” device. In general, covert marking requires a system wherein the presence of the marker can be picked up and/or verified using some system that is sensitive to the marker. The reading device typically has a display that can instantly provide overt information acquired from the covert marker and thereby verify the authenticity of the article at the time of the transaction. The advantage of using a covert marker is that it can stifle attempts by a predator to take steps to disable or otherwise defeat purpose of the marker. Also, should fraud be attempted with articles that are covertly marked and the predator is not aware of the marker, the predator may be identified and dealt with by legal authorities when the fraud is detected. A covert method for detection of fraud is described in U.S. Pat. No. 6,442,276 B1, which describes a method whereby random codes are provided for marked goods and a database of the random codes is kept to confirm or deny authenticity.

It is noteworthy that what can be an overt marker can also be used in a covert manner, so that the overt marker would then be considered a covert marker. Alternatively, what is typically considered a covert marker, if used in an overt manner, would then be considered an overt marker. Further, the relative ease of discovery of a covert marker may make it semi-covert or even semi-overt. Similarly, an overt marker can have various degrees of overtness. Thus, it is clear that the way a marker is used can be the determining factor as to whether it is considered an overt marker or a covert marker. What is consistent in the conventional use of various markers is that identification and verification of the markers occurs at the time of the transaction. As a result the principal parties, including a possible predator, have immediate notification as to the result of the identification/verification of the marked article, and the fraud can be immediately detected and/or deterred.

Marking practice is not without its problems, however. Overt markings can be removed, hidden, or otherwise made ineffective in providing the desired information needed for authentication. Covert markings, once discovered by a predator, can be made ineffectual by the same methods used to defeat the effectiveness of the overt markings. Also, the markers can be copied or reproduced in such a way that a casual observer can be fooled into believing that illicit articles are in fact legitimate articles.

In any event, marking alone is not very effective for analyzing trends in the occurrence of fraud, or developing data for tracking the point or source of some types of fraudulent transactions, for example counterfeiting.

In the conduct of business transactions wherein authenticity of goods can be an issue, it can be desirable to provide a method of commerce whereby illicit articles can be detected immediately at the point of transfer in addition to providing a method for developing covert historical data on the occurrence of fraud for a particular article of manufacture. It would further be desirable to provide a method of commerce whereby the historical data can be used to determine trends that can be useful in eliminating predatory fraudulent activity with respect to a particular article of manufacture. It would further be desirable to provide a method of commerce whereby marked articles in commerce can be tracked and traced by using a historical database developed on those same articles.

### SUMMARY OF THE INVENTION

In one aspect, the present invention is a method of commerce comprising the steps of: (1) marking a sealed and/or packaged article of commerce with at least one overt marker that is capable of producing a signal that is readable by a means for sensing and reading the signal, and at least one covert marker that is capable of producing a signal that is readable by a means for reading and sensing a signal, and providing at least one signal sensing means for the purpose of reading the overt and covert signals; (2) reading signals generated from the at least one overt marker and the at least one covert marker; (3) providing at least one means for storing and accumulating, in a covert memory, data obtained from the at least one overt marker and/or the at least one covert marker; (4) providing a means for analyzing the data from the at least one overt marker and/or at least one covert marker; (5) generating information about the article obtained from the analyses of the data from the at least one overt marker and/or at least one covert marker; (6) sending a first portion of the information obtained from the data to an overt display; (7) storing a second portion of the information obtained from the data in the covert memory.

In another aspect, the present invention is a method of commerce comprising the steps of: (1) marking a sealed and/or packaged article of commerce with at least one overt marker that is capable of producing a signal that is readable by at least one signal sensing system and at least one covert marker that is capable of producing a signal that is readable by at least one signal sensing system; (2) reading the signals from the at least one overt marker and the at least one covert marker with at least one signal sensing system; (3) providing at least one processor having covert memory for storing and accumulating data obtained from the at least one overt marker and/or the at least one covert marker; (4) analyzing the data from the at least one overt marker and/or at least one covert marker using processor readable instructions and the at least one processor; (5) using the at least one processor to generate information about the article from the data obtained from the at least one overt marker and/or the at least one covert marker; (6) sending a first portion of the information to an overt display; (7) storing a second portion of the information in the covert memory.

In another aspect, the present invention is a history of stored information obtained by a process comprising the steps of: (1) marking a sealed and/or packaged article of commerce with at least one overt marker that is capable of producing a signal that is readable by at least one signal sensing system and at least one covert marker that is capable of producing a signal that is readable by at least one signal sensing system; (2) reading the signals from the at least one overt marker and the at least one covert marker with at least one signal sensing system; (3) providing at least one processor having covert memory for storing and accumulating data obtained from the at least one overt marker and/or the at least one covert marker; (4) analyzing the data from the at least one overt marker and/or at least one covert marker using processor readable instructions and the at least one processor; (5) using the at least one processor to generate information about the article from the data obtained from the at least one overt marker and/or the at least one covert marker; (6) sending a first portion of the information to an overt display; (7) storing a second portion of the information in the covert memory.

In another aspect, the present invention is a process for determining fraud in commercial transactions comprising the steps: (1) obtaining information from a marked sealed and/or packaged article; and (2) maintaining at least a portion of that information in a covert memory, wherein the article comprises at least one covert marker and at least one overt marker, and wherein each of the at least one markers is capable of emitting signals that are readable by a signal reading device.

### BRIEF DESCRIPTION OF THE DRAWINGS

FIG. 1 is a flow chart illustrating one embodiment of the invention.

FIG. 2 is a flow chart illustrating another embodiment of the invention.

FIG. 3 is a flow chart illustrating another embodiment of the invention.

FIG. 4 is a flow chart illustrating another embodiment of the invention.

### DETAILED DESCRIPTION OF THE INVENTION

In one embodiment, the present invention is a process for determining the occurrence of fraud as it relates to an article of commerce. As used herein, the term fraud means the intentional distortion of the truth for the purpose of inducing another to part with a thing of value. Examples of fraudulent acts, for the purposes of the present invention, include: the substitution of one article for another without permission or right, wherein the articles are purported to be identical or substantially similar but actually are not (counterfeiting); the modification of an article resulting in a substantial decrease in the performance, potency, or quality of an article without providing notice to a subsequent purchaser that the article has been so modified (dilution); intentionally providing false or misleading information about the identity, composition, quantity, or quality of an article. Other fraudulent acts are known and practiced, and may be deterred by the process of the present invention.

An article of commerce that can be marked, tracked, and traced according to the process of the present invention is any article that is used in conducting commercial transactions. For example, an article of commerce can be: any manufactured article; currency; a document; artwork; a bank draft (check); a license; and the like.

In the practice of the present invention, at least one overt marker is placed on, included with, or incorporated on or into a sealed and/or packaged article. Any overt marker or multiplicity of markers can be suitable, with the proviso that at least one of the overt markers used is capable of emitting a signal that can be detected and is readable by a suitable signal sensing device or system. Suitable overt markers for use in the practice of the present invention include, for example visible holograms, trademarks, trade symbols, visible bar codes, serial numbers, and company names. As used herein, an overt marking is a marking that can be optically detected by a person with 20/20 vision from a distance of at least 0.5 meters. In the practice of the present invention at least one covert marker is used in combination with the at least one overt marker. The at least one covert marker is placed on, included with, or incorporated into a sealed and/or packaged article. Any covert marker or multiplicity of covert markers can be suitable for use herein, with the proviso that at least one of the covert markers used is capable of emitting a signal that can be detected and is readable by a signal sensing device or system. The signal from the covert marker should be compatible and not interfere with the signal from the overt marker. Suitable covert markers include, for example: hidden bar codes; inks or dyes that are visible only under certain conditions such as when excited with a source electromagnetic radiation (e.g. ultraviolet radiation), and a Radio Frequency Identification (RFID) buried and invisible in a corrugated cardboard packaging material. As used herein, the covert marking is a marking that cannot be optically detected by a person with 20/20 vision from a distance of at least 0.5 meters. A covert marker comprising at least in part a RFID is preferred. A covert marker comprising at least in part a RFID having memory can be more preferred where storage of electronic information is desirable. A covert marker comprising at least in part a chipless RFID can be preferred for low cost applications. A covert marker comprising at least in part a RFID having an integrated circuit chip can be particularly preferred in applications having higher functionality and versatility. A covert marker free of any radio frequency antenna can be preferred for low cost applications.

In the practice of the invention, the signal sensing system or systems for the covert and/or overt markers is preferably portable.

In the practice of the present invention, a marked article comprises a plurality of markers that generate a plurality of detectable signals. More preferably, the marked article comprises a multiplicity of markers that generate a multiplicity of detectable signals. The number of distinguishable signals can depend on the number of markers that are capable of generating a signal and are included with the marked article. Any number of distinguishable signals from the markers are contemplated by the present invention, as long as the signals generated by the plurality, more preferably a multiplicity, of markers do not interfere with each other and/or are otherwise readable by a signal sensing device or system. A suitable readable signal for the purposes of the present invention can be a photometric signal, magnetic signal, electrical signal, radio signal, or the like. A preferred readable signal is an electromagnetic signal, such as may be detected by a global position indicator system or the like.

Any overt or covert marker and any marking/detection method that are conventional and known are contemplated and can be useful in the practice of the present invention. For example, U.S. Pat. No. 6,138,913 describes a method of marking a security document using a technique that utilizes a covert fluorescent compound to imprint encoded information. U.S. Pat. No. 6,477,227 B1 describes a process by which taggants are placed in an article, such taggants being detectable by x-ray fluorescence. A preferred overt marker is selected from the group consisting of visible holograms, colored markers, markers having a distinguishable pattern, and magnetic markers. It can be more preferred to mark the article with a plurality of overt markers selected from the group consisting of visible holograms, colored markers, markers having a distinguishable pattern, and magnetic markers or any combination thereof.

Preferred covert markers include markers selected from the group consisting of: hidden markers, transparent markers, fluorescent markers, phosphorescent markers, bioactive markers, non-human detectable off-gas, non-visible taggants, bioderived markers, organic material-containing markers, markers comprising inorganic material, latent image markers, covert RFID markers, covert chipless RFID markers, thermochromic markers, devices that transmit electromagnetic signals detectable by a global position indicator system, and the like. It can be more preferred to include more than one covert marker with the sealed and/or packaged article, and even more preferred to include more than two covert markers. More preferred covert markers are selected from the group consisting of invisible luminescent markers, hidden markers having a distinguishable pattern, hidden RFID, and hidden magnetic markers. It can be even more preferred to use a plurality of covert markers selected from the group consisting of invisible luminescent markers, hidden markers having distinguishable patterns, hidden RFID, and hidden magnetic markers or combinations thereof.

Various overt and covert markers are known conventionally and described in various published sources. Any known method of marking a sealed or packaged article by overt means, covert means, or any combination of overt means and covert means is contemplated as within the scope of the present invention inasmuch as the present invention provides a novel use of the overt and covert marking processes that are conventionally known.

The present invention requires at least one means for storing and accumulating data. For example, the means for storing and accumulating data can be a processor that is capable of storing signal information obtained from the marked articles and also capable of accessing and implementing processor readable instructions. Suitable processor readable instructions for the practice of the present invention comprise, for example, an algorithm suitable for evaluating the information obtained from the signal generated by the marked article. Preferably, the processor comprises an application-specific integrated circuit (ASIC). Preferably, the ASIC has access to ASIC processor readable instructions. Also preferably, the processor has access to at least one output device, such as a display or printer. Preferably, the overt and/or covert information is evaluated by a method such as, for example, statistical analysis; neural network analysis; artificial intelligence; data mining; mathematical algorithm; and the like.

In some preferred embodiments of the invention, there are two or more processors, at least one of which may access the overt and/or covert memory, and at least one of which has access to one or more output devices. For example, the covert memory may be accessed using a second processor to evaluate information stored on a plurality of articles of commerce, and the information and/or evaluation obtained from the information in the covert memory may be displayed on a second display. Information evaluated by the processor can be partitioned for output to an overt display and to a memory that is covert inasmuch as it is unknown to the parties at the time of the transaction that information is being stored in a covert memory bank. In some embodiments of the invention, the information sent to the overt display does not include information that can authenticate the article. In some embodiments of the invention, the covert memory includes information that can authenticate the article. In some embodiments of the invention, the information sent to the overt display does not include information that can authenticate the article and the covert memory includes information that can authenticate the article.

Preferably the covert memory bank is accessible under certain preferred conditions such as when sending covert information to a remote, preferably centralized, historical database. Preferably, the covert memory bank is protected such that the means for accessing the covert memory comprise at least one step of providing a passcode. A passcode as the term is used herein is a code, sequence, or pattern comprising numbers, letters, and/or symbols in any combination that can identify and authorize access to the covert memory. Preferably, new information is added to the historical database and/or covert memory after each transaction, or after one or more steps of the process of the invention. A processor having access to covert memory is a preferred. Covert memory is a term used herein to define files, data, programs, or other information that is hidden from a customer, consumer, or other buyer; buyer's agent; seller; seller's agent; or party with no authority to view the covert memory. This does not mean that one skilled in the art of finding covert information would not be able to obtain unauthorized access to the covert information. Covert memory and/or covert information as the terms are used herein mean memory or information that is intended to be hidden from unauthorized persons. There can be a number of preferred examples of covert memory and/or information suitable for the purposes of the present invention. A background file is an illustrative example of a preferred covert memory and a plurality of background files can be a more preferred illustrative example of a covert memory. A background memory is an illustrative example of a covert memory. A hidden file is an illustrative example of a covert memory and a plurality of hidden files can be a more preferred illustrative example of a preferred covert memory. A hidden memory is an illustrative example of a preferred covert memory. A hidden database is a preferred example of a hidden file. Hidden files and background files are generally known to those skilled in the computer arts and can be generally be used with the guidance and teachings contained herein.

The steps of the processes of the invention may be performed sequentially, simultaneously, or at least partially simultaneously. The term “sequentially”, as used herein regarding the relative timing of the performance of the process steps, refers to performing each step during a time period that does not overlap with the time period during which another step is performed. For example, one step is performed during a time period from 00:00 min:sec to 00:05 min:sec, and another step is performed during a time period from 00:06 min:sec to 00:10 min:sec. The term “simultaneously”, as used herein regarding the relative timing of the performance of the process steps, refers to performing the process steps during an identical time period. For example, two of the steps of the process of the invention are carried out during a time period from 00:00 min:sec to 00:05 min:sec. Alternatively, two or more process steps may be carried out at least partially simultaneously, i.e., during overlapping time periods. For example, one step of the process of the invention is executed during a time period from 00:00 min:sec to 00:05 min:sec, and another step of the process is executed during a time period from 00:03 min:sec to 00:08 min:sec. To further illustrate the point, if there is yet another process step in a process whose steps are performed at least partially simultaneously, it may be executed during a time period from 00:06 min:sec to 00:10 min:sec; alternatively, it may be executed during a time period from 00:10 min:sec to 00:15 min:sec. Partially simultaneous steps can further include, for example, process steps wherein one step is initiated and executed completely and wholly within the period of time during which another of the process steps is being executed.

Time periods in the above non-limiting examples of suitable relative timings of the performance of the process steps are measured from an arbitrary starting time 00:00 min:sec that may preferably correspond to the time at which the overt and/or covert marking is first read. It is to be understood, however, that the units of time used in the examples above are not limiting. Specifically, the process steps may require substantially longer or shorter periods of time than are exemplified above, and the processes of the invention may be carried out over substantially longer or shorter periods of time. Substantially longer periods of time include, for example, hours, days, weeks, and months, as is set forth elsewhere herein. It is also to be understood that the steps of the processes of the invention may be carried out in any sequence that is operable, regardless of the order in which the steps are described, unless otherwise specified herein for a certain embodiment, e.g.

Preferably, when the process steps are performed sequentially or at least partially simultaneously, they are also performed within a predetermined time period. Preferably, the predetermined time period is one day or less, six hours or less, two hours or less, one hour or less, 30 minutes or less, 15 minutes or less, 10 minutes or less, five minutes or less, or one minute or less. Also preferably, one or more of the process steps are carried out in real time. The term “real time”, as used herein, means sequentially, simultaneously or partially simultaneously with the transaction, with the proviso that sequential steps executed in real time take place without a significant increase in the total time required to perform all of the process steps. An increase in total time of greater than 75% is considered significant in the practice of the present invention.

In a process of the invention comprising the steps of (1) obtaining information from a marked, sealed and/or packaged article; and (2) maintaining at least a portion of that information in a covert memory, steps (1) and (2) may be performed during a predetermined time period; in real time; sequentially; simultaneously; at least partially simultaneously; or under a combination of these conditions, such as, for example, at least partially simultaneously during a predetermined time period, or in real time and sequentially.

In another embodiment the present invention is a method of using information obtained from marked articles and stored in a covert memory to track authentic articles, trace the movement of authentic articles, analyze trends and recognize problems in commercial transactions using the information obtained from marked articles.

In still another embodiment, the present invention is a history of commercial transactions obtained from a marked article of the present invention. A history of commercial transactions according to the present invention is derived from information obtained from the signals generated by the markers placed on or included with packaged articles described herein. The information can be obtained at different times, or at different locations or at both different times and different locations. Preferably, data from transactions are obtained from the marked article at more than one different location. More preferably, data from transactions are obtained from the marked article in at least 3 different locations or at least 5 different locations, and even more preferably data from transactions are obtained from the marked article in at least 10 different locations. Preferably, data from transactions are obtained from the marked article at more than one different time. More preferably, data from transactions are obtained from the marked article at least 3 different times or at least 5 different times, and even more preferably data from transactions are obtained from the marked article at least 10 different times. Preferably, data from the transactions are obtained from the marked article at different times and wherein each transaction occurs in a different location. By obtaining data from multiple transactions involving a marked article, a trail or history can be developed to facilitate a determination of where the article is diverted and/or counterfeited. Preferably the history includes times and/or locations of each transaction. Preferably the history is at least in part covert and unknown by the predator. More preferably the history is covert and unknown by the predator. By having the history covert and unknown to the predator, it is more difficult for a predator to develop a method for making fraud detection less effective, or defeating the attempts at fraud detection completely.

In still another embodiment, the present invention is a history of commercial transactions obtained from at least two marked articles of the present invention. A history of commercial transactions according to the present invention is derived from information obtained from the signals generated by the markers placed on or included with packaged articles described herein. Each transaction may involve one or more of the marked articles. Preferably, the transaction or transactions involve more than one marked article. More preferably, the transaction or transactions involve at least 5 marked articles, and even more preferably, the transaction or transactions involve at least 10 marked articles. Ultimately, the number of marked articles used in the method of the present invention can be determined on a case-by-case basis, according to the circumstances and the need to provide more or less marked articles and obtain a successful result, which is thwarting a would-be predator's success. Preferably, the articles belong to the same genus, i.e., currency or watches. More preferably, the articles are fungible, i.e., a particular denomination of U.S. currency, or a particular make and model of watch.

The information can be obtained at different times, or at different locations or at both different times and different locations. Preferably, data from transactions are obtained from the marked articles at more than one different location. More preferably, data from transactions are obtained from the marked articles in at least 3 different locations or at least 5 different locations, and even more preferably data from transactions are obtained from the marked articles in at least 10 different locations. Preferably, data from transactions are obtained from the marked articles at more than one different time. More preferably, data from transactions are obtained from the marked articles at least 3 different times or at least 5 different times, and even more preferably data from transactions are obtained from the marked articles at least 10 different times. Preferably, data from the transactions are obtained from the marked articles at different times and wherein each transaction occurs in a different location. By obtaining data from multiple transactions involving a series of marked articles, a trail or history can be developed to facilitate a determination of where the articles are diverted and/or counterfeited. Preferably the history includes times and/or locations of each transaction. Preferably the history is at least in part covert and unknown by the predator. More preferably the history is covert and unknown by the predator. By having the history covert and unknown to the predator, it is more difficult for a predator to develop a method for making fraud detection less effective, or defeating the attempts at fraud detection completely.

A processor having access to covert history in at least one hidden file and/or at least one background file is preferred. A processor having access to covert history in at least one hidden memory and/or at least one background memory is preferred. A history as described herein can be useful for analyzing trends in the movement of illicit and/or authentic articles of commerce. By creating a covert history, the invention works with a new and different structure in a new and different way to give a new and different, valuable result. One aspect of the problem heretofore has been the ability of the predator to adapt methods of defeating the fraud detection measures taken by the legitimate businessperson because the detection of the fraud was made apparent to the predator at the time of the transaction. The present invention can confuse a predator because the predator would not be aware of what led to discovery of fraud, and/or would be unable to reproduce the information obtained from the marked article. Discovery of the problem is considered part of the invention.

Various articles can be tracked and traced by the process of the present invention. Without limiting the types of articles suitable for protection in the practice of the present invention, a suitable marked article can be selected from the group consisting of: agricultural products; agricultural chemical products; alcoholic beverages; perfumes; automotive parts; pharmaceutical products; other automotive products; aerospace parts; mechanical parts; military products; electronic products; or marked articles having a tradename, a trademark, and/or a logo. Articles that can generate revenue of at least $1,000,000 are particularly preferred articles for protection by the process of the present invention.

Illustrative nonlimiting examples of useful technology have been disclosed herein together with teaching and guidance in the use of such technology for the purpose of thwarting a perpetrator. It is to be understood that the methods described herein for thwarting a predator can be practiced using different overt and covert markers. Variations using the teachings and guidance as described herein can be combined with generally known and conventional practices to accomplish the goals set out herein.

For a better understanding of the invention, its advantages, and the objects obtained by its use, reference may be made to the drawings, and to the accompanying descriptive text, in which a preferred embodiment of the invention is illustrated and described. Throughout the drawings, like reference numerals designate corresponding structures and/or steps.

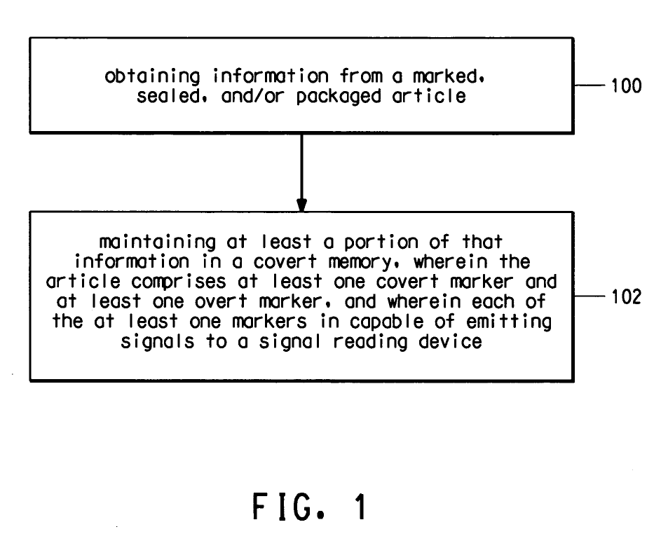

FIG. 1 is a process flowsheet of one embodiment of the present invention. In Step 100 information is obtained from a marked article. A portion of that information can be overtly displayed at the point of the transaction. In Step 102 at least a portion of the information obtained from the marked article is held in a covert memory. The covert memory can be maintained for an extended period. Preferably the covert memory is maintained for at least 1 hour or more. More preferably, the covert memory is maintained for at least eight (8) hours or more, and more preferably the covert memory is maintained for at least 24 hours or more. It is most preferable that the covert memory be maintained for a time sufficient to accumulate historical information for transactions involving marked articles of that type for at least 30 days or more.

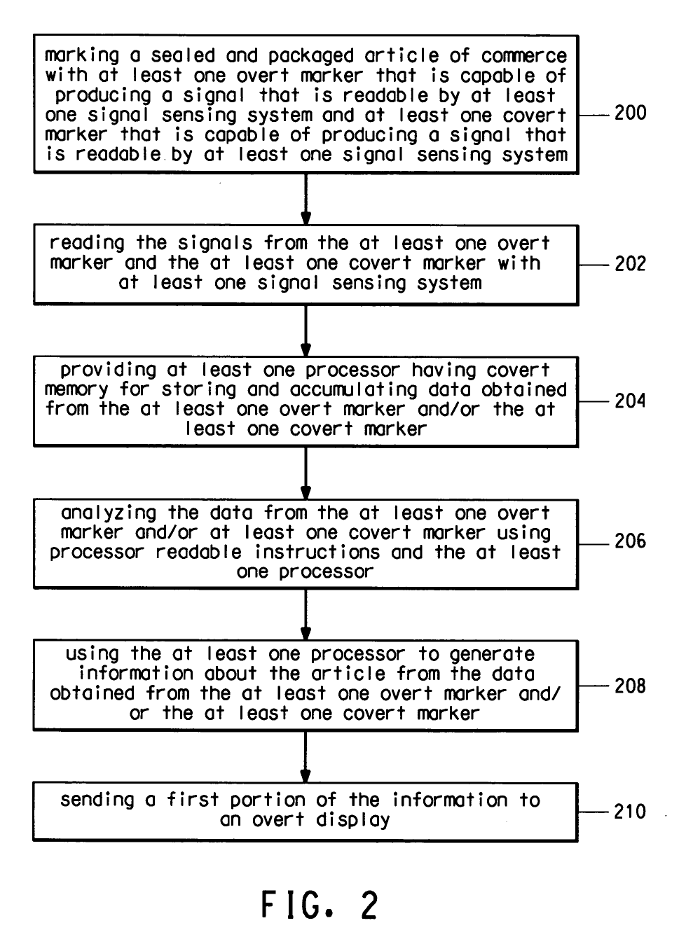

FIG. 2 is a process flowsheet for another embodiment of the present invention describing the steps of providing a marked article that comprises both overt and covert markers that are capable of generating signals readable by a signal reading device 200, reading signals produced from said markers 202, storing the information obtained from the markers 204, analyzing the information using a processor implementing processor readable instructions 206, generating information about the article using the processor 208, and sending a portion of the information to an overt display 210.

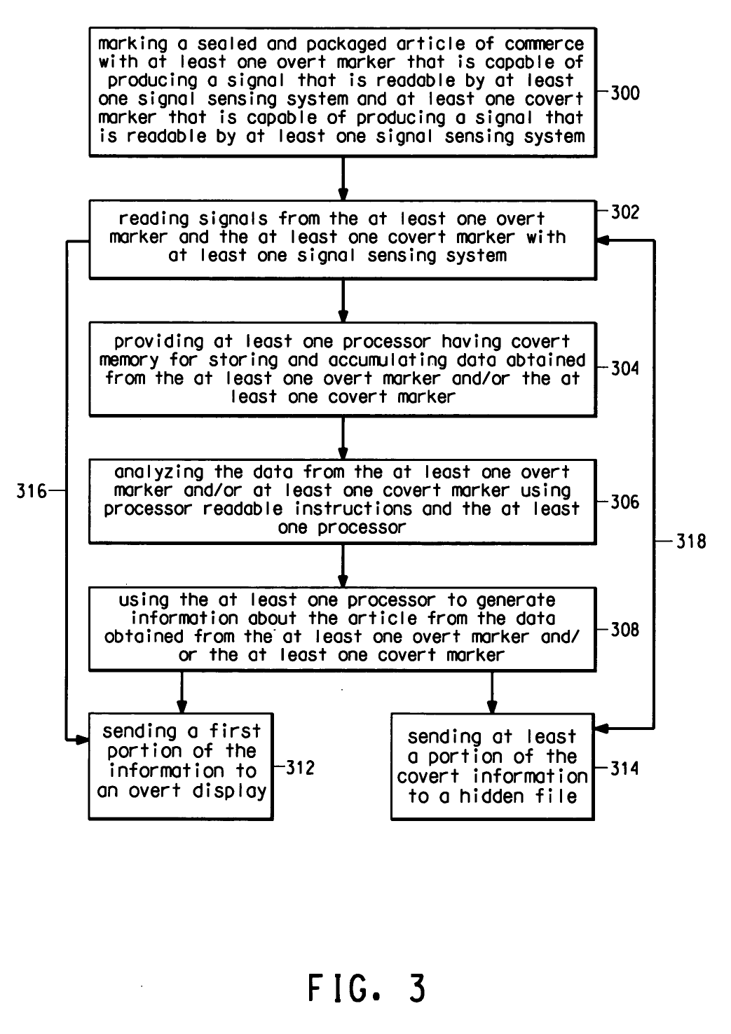

FIG. 3 is a process flowsheet for still another embodiment of the present invention, illustrating the steps of marking a sealed and/or packaged article of commerce with at least one overt marker that is capable of producing a signal that is readable by at least one signal sensing system and at least one covert marker that is capable of producing a signal that is readable by at least one signal sensing system 300; reading the signals from the at least one overt marker and the at least one covert marker with at least one signal sensing system 302; providing at least one processor having covert memory for storing and accumulating data obtained from the at least one overt marker and/or the at least one covert marker 304; analyzing the data from the at least one overt marker and/or at least one covert marker using processor readable instructions and the at least one processor 306; and using the at least one processor to generate information about the article from the data obtained from the at least one overt marker and/or the at least one covert marker 308. The embodiment illustrated in FIG. 3 further comprises the steps of sending information generated by the processor to an overt display 312 and/or sending covert information to a covert, or hidden, file 314. The process further comprises one or more loops 316 and 318 wherein information from the marked article can be repetitively and/or continuously fed to the overt display 312 and/or the hidden file 314.

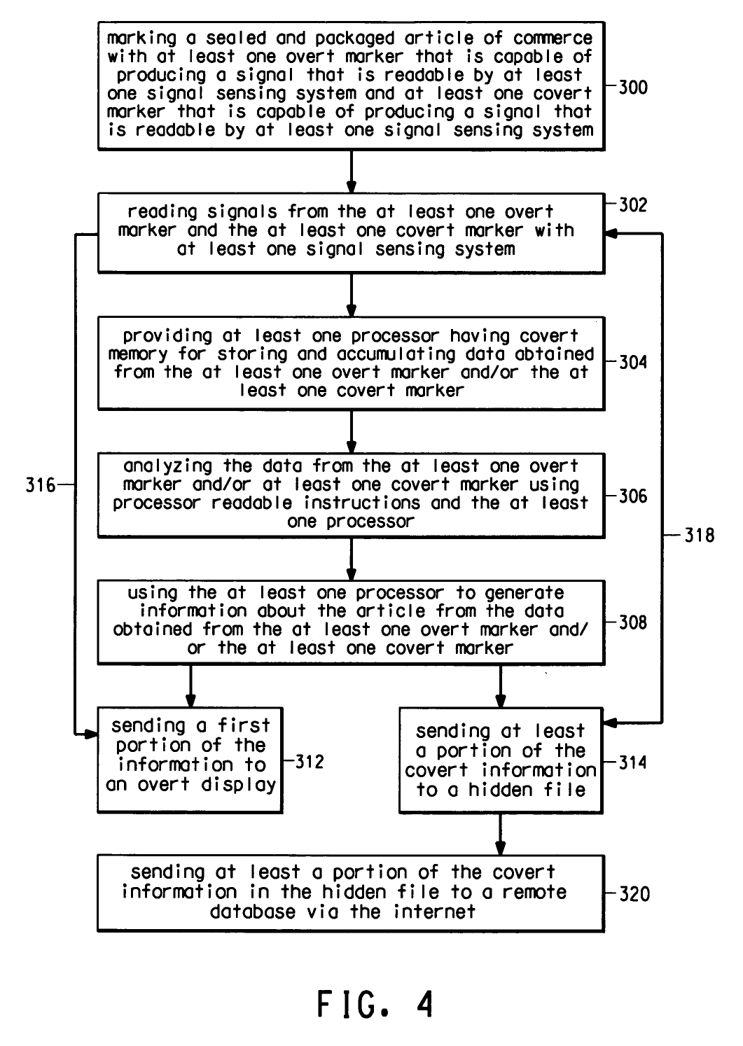

FIG. 4 is process flowsheet of yet another embodiment of the present invention, which comprises the embodiment set forth in FIG. 3 and described in detail above. The embodiment depicted in FIG. 4 further comprises the step of sending at least a portion of the covert information in the hidden file to a remote database or other covert memory via the Internet 320. The information sent via the Internet can be encrypted to discourage pirating the information as it is being transferred. Numerals 316 and 318 represent the optional, but preferred, repetition of one or more steps in the method.

The scope of the invention is determined by the scope of the claims appended hereto rather than the specific preferred embodiments and details described by the Example.

### EXAMPLE

The Example is for illustrative purposes only, and is not intended to limit the scope of the invention. Further the illustrative steps may be combined or separated into additional steps as will be generally appreciated by those skilled in the relevant arts and using the disclosure and guidance contained herein.

### Example 1

A product is sealed in a package material having a conventional overt marking (such as a bar code) and a covert luminescent marker (such as a bar code only visible when excited by ultraviolet electromagnetic radiation). Suitable luminescent markers are available commercially from Spectra Systems Corporation in Providence, R.I. A “Vericam” reader, which is also available from Spectra Systems Corporation, or a similar reader having an ultraviolet source, is used to excite the covert marker and detect the signals therefrom. The “Vericam” is modified to display some overt information (such as product type) and to store in covert memory the covert information relating the authenticity of the product. After a time delay, the covert information in the covert memory is transferred to a historical database. The above detection is repeated a number of times to build covert historical information which is then transferred in whole or in part to the historical database. The historical database information is then evaluated to determine historical trends of the authenticity of the product.

What is claimed is:

1. A method of commerce useful for determining fraud in commercial transactions comprising the steps: (1) obtaining information from a marked, sealed and/or packaged article; and (2) maintaining at least a portion of that information in a covert memory, wherein the article comprises at least one covert marker and at least one overt marker, and wherein each of the at least one markers is capable of emitting signals to a signal reading device.

2. A method of commerce comprising the steps of: (1) marking a sealed and/or packaged article of commerce with at least one overt marker that is capable of producing a signal that is readable by at least one signal sensing system and at least one covert marker that is capable of producing a signal that is readable by at least one signal sensing system; (2) reading the signals from the at least one overt marker and the at least one covert marker with at least one signal sensing system; (3) providing at least one processor having covert memory for storing and accumulating data obtained from the at least one overt marker and/or the at least one covert marker; (4) analyzing the data from the at least one overt marker and/or at least one covert marker using processor readable instructions and the at least one processor; (5) using the at least one processor to generate information about the article from the data obtained from the at least one overt marker and/or the at least one covert marker; (6) sending a first portion of the information to an overt display; (7) storing a second portion of the information in the covert memory.

3. The method of claim 2 wherein the signals are analyzed using an algorithm implemented by the at least one processor.

4. The method of claim 3 wherein the information stored in the covert memory is a combination of information obtained from the at least one overt marker and information obtained from the at least one covert marker.

5. The method of claim 2 wherein the signal sensing system includes a global position indicator system.

6. The method of claim 5 wherein the global position indicator system is covert.

7. The method of claim 6 wherein the covert memory includes information obtained from the global position indicator system.

8. The method of claim 2 wherein the information sent to the overt display does not include information that can authenticate the article.

9. The method of claim 2 wherein the covert memory includes information that can authenticate the article.

10. The method of claim 7 wherein a means for accessing the covert memory is provided and wherein the means for accessing the covert memory comprise at least one step of providing a passcode.

11. The method of claim 7 wherein the information stored in the covert memory has been encrypted prior to storage in the covert memory.

12. The method of claim 7 wherein the method further comprises the steps of: accessing the covert memory using a second processor to evaluate information stored on a plurality of articles of commerce; and, displaying on a second display the information and/or evaluation obtained from the information in the covert memory.

13. The method of claim 8 wherein the sensing system further comprises at least one ASIC processor having access to ASIC processor readable instructions and an output device, wherein the processor readable instructions include an algorithm.

14. The method of claim 12 wherein the method used to evaluate the information in the covert memory is selected from methods of: statistical analysis; neural network analysis; artificial intelligence; data mining; and mathematical algorithm.

15. The method of claim 14 wherein the method for evaluation comprises a mathematical algorithm.

16. The method of claim 14 wherein the evaluation comprises a neural network.

17. The method of claim 2 wherein the sensing system is portable.

18. The method of claim 17 wherein the sensing system comprises one unit for reading the signal.

19. The method of claim 1 wherein one or more of the method steps is repeated at least 3 times.

20. The method of claim 19 wherein one or more of the method steps is repeated in at least 3 different locations.

21. The method of claim 1 wherein one or more of the steps is repeated at least 10 different times, and wherein information can be added to the covert memory at each repetition of the one or more steps.

22. The method of claim 21 wherein one or more of the method steps is repeated in at least 10 different locations and further comprising the step of building a historical database with the information maintained in the covert memory.

23. The method of claim 20 wherein:
the information sent to the overt display is free of information that can authenticate the article; the information sent to the covert memory includes information that can authenticate the article; and the covert information is used to build at least one remote historical database having information relating to the authenticity of the product.

24. The method of claim 20 wherein the method comprises the step of sending at least a portion of the covert information over the Internet to a remote historical database.

25. The method of claim 20 wherein the sealed and/or packaged article is an article selected from the group consisting of: agricultural products; agricultural chemical products; alcoholic beverages; perfumes; automotive parts; pharmaceutical products; other automotive products; aerospace parts; mechanical parts; military products; electronic products; or marked articles having displayed thereon one or more of a tradename, a trademark, or a logo.

26. A method of commerce comprising the steps of: (1) marking a sealed and packaged article of commerce with at least one overt marker that is capable of producing a signal that is readable by a means for sensing and reading the signal, and at least one covert marker that is capable of producing a signal that is readable by a means for reading and sensing a signal, and providing at least one signal sensing means for the purpose of reading the overt and covert signals; (2) reading signals generated from the at least one overt marker and the at least one covert marker; (3) providing at least one means for storing and accumulating, in a covert memory, data obtained from the at least one overt marker and/or the at least one covert marker; (4) providing a means for analyzing the data from the at least one overt marker and/or at least one covert marker; (5) generating information about the article obtained from the analyses of the data from the at least one overt marker and/or at least one covert marker; (6) sending a first portion of the information obtained from the data to an overt display; (7) storing a second portion of the information obtained from the data in the covert memory.

27. The method of claim 20 wherein the covert marker comprises at least in part a RFID.

28. The method of claim 27 wherein the RFID has a memory.

29. The method of claim 27 wherein the RFID does not include an integrated circuit chip.

30. The method of claim 27 wherein the RFID comprises an integrated circuit chip.

31. The method of claim 20 wherein the covert marker does not include a radio frequency antenna.

32. The method of claim 1, wherein steps (1) and (2) are performed in real time.

33. The method of claim 1, wherein steps (1) and (2) are performed simultaneously.

34. The method of claim 1, wherein steps (1) and (2) are performed during a predetermined time period.

35. The method of claim 1, wherein steps (1) and (2) are performed at least partially simultaneously.
